(19) United States
(12) Patent Application Publication
(10) Pub. No.: US 2009/0200075 A1
(43) Pub. Date: Aug. 13, 2009

(54) Method and apparatus for concealed installation of wires, cables, fibers, pipes and the like within a structure

(76) Inventor: Mike L. Massey, Midland, TX (US)

Correspondence Address: LAW OFFICES OF CHRISTOPHER L. MAKAY, 1634 Milam Building, 115 East Travis Street, San Antonio, TX, 78205, US

(21) Appl. No.: 12/069,477

(22) Filed: Feb. 11, 2008

(51) Int. Cl. H02G 3/04; H02G 3/30

(52) U.S. Cl. 174/481

(57) ABSTRACT

A method and apparatus for concealing and installing wires, cables, fibers, pipes and the like within a conduit is made from a flexible, paintable material, preferably plastic, metal, a composite paper material or the like. The conduit is customizable in size and shape from its original convenient flat state for installation within a structure. The size and shape of the conduit may be adjusted by cutting the conduit in its flat state to the desired length, and bending the conduit along scored indentations to allow for shaping the conduit into the desired form.

### BACKGROUND OF THE INVENTION

1. Field of the Invention

The present invention relates to a method and apparatus for concealing and installing wires, cables, fibers, pipes and the like within a structure.

2. Description of the Related Art

Construction of commercial and residential structures is usually regulated at the local government level. Ordinances and regulations are enacted by governments to insure that construction is done in a manner that protects the health and safety of its citizens. In most cases, jurisdictions adopt a model code as set out by a governing agency or advisory body for that particular aspect of building construction. Examples are the International Building Code and the International Fire Code. Typically, a governmental entity will incorporate a model code into its own local code by ordinance and amend or supplement sections to address that jurisdiction's specific needs.

For the installation of electrical components, The National Electrical Code has been adopted by many governmental entities in the United States. This code regulates the installation of electrical conductors, equipment and raceways in public and private premises, including buildings, structures, mobile homes, recreational vehicles, and floating buildings.

Certain types of wiring in premises may be required by code to be installed in “raceways.” Even if not required by code, an installer may elect to use raceways to protect the wiring for other reasons.

Raceways are defined by the National Electrical Code as “an enclosed channel of metal or nonmetallic materials designed expressly for holding wires, cables, or busbars, with additional functions as permitted in this Code. Raceways include, but are not limited to, rigid metal conduit, rigid nonmetallic conduit, intermediate metal conduit, liquid tight flexible conduit, flexible metallic tubing, flexible metal conduit, electrical nonmetallic tubing, electrical metallic tubing . . . . ”

In the construction of homes, buildings and other structures, there are a lack of convenient methods and equipment for initially housing low voltage wires and cables, such as that used for telephone, television, computer networking, etc. There is also no convenient equipment or methods existing for the later adding or changing of low voltage wiring and cabling. There is a need for equipment used in the initial installation or later renovation of a structure that allows for the convenient addition of wires, cables, fibers and the like, such as in remodeling of a home or the upgrading of the data transmission capabilities in an office.

Currently, round pre-shaped conduits are commonly utilized to enclose and house these wires and cables. However, using these conduits presents several problems.

One problem is that round conduits are expensive to produce, store and ship. Prior to being cut and installed, round pre-shaped conduits are bulky and take up significant space. Because pre-shaped round conduit must contain a hollow space for the enclosure of wires, cables, and the like, this increases the overall size of the conduit because of the space the hollow portion displaces. While this hollow portion does not increase the weight of the conduit, it does increase the size of the conduit. This increased size leads to higher storage and shipping costs. Also, because of their round shape and length, they are cumbersome to handle and awkward to move from place to place before and during installation.

An additional problem with round conduit is the difficulty in cutting sections for use. Round conduits must be cut to length. The hollow created by the round shape makes it difficult or impractical to stack and cut more than one section at a time since the surface area being cut is spread out by the hollow interior of the conduit.

Another problem with pre-shaped round conduit is that it does not have its own integrated attachment method which can be used to fasten it to walls, beams, joists or other parts of a structure. Round conduit must be fastened to surfaces with separate straps or clips in order to secure them.

Another disadvantage to pre-shaped round conduit is that it is usually manufactured in standard sizes of 0.75 inches or 1.0 inches diameter, primarily because of the cost of the material used to manufacture it and the industry need for standardization. This diameter makes it difficult to add additional wiring later. It also does not allow for storing excess wiring or cable within the conduit during the “rough-in” phase. Excess wire or cable at the termination point is necessary so that enough remains to attach fixtures and switches without having to splice wires together. Usually, this excess is stored in the gang box. If an installer can test and terminate the wiring or cable, with the necessary excess amount to be stored within the conduit and not in the gang box, the wiring and cable are protected from paint, plaster and other materials used to finish out a construction project. If stored in a gang box, the only way to protect the excess wire or cable is by physically covering the gang box, which may not be effective if high pressure spraying is used to apply paint or other surfacing material.

A conduit that could be manufactured flat, in one piece, with no seams, equipped with built-in flanges for surface attachment that can be shaped, cut, and installed easily would be significantly advantageous.

The ability to initially install and allow for the future addition of wires and cables inside walls and cavities during new construction of buildings and home and later remodeling projects would also be a significant advantage.

### SUMMARY OF THE INVENTION

In accordance with the present invention, a flat flexible conduit for enclosing and concealing wires, cables, fibers and other strands of material in new and existing houses and buildings.

The flat conduit is a one piece, flat, flexible thin material made from plastic, paper fiber, metal, polyvinyl or the like that can be shipped, stored, cut and transported around warehouses, construction sites or buildings in a flat state, then prior to shipping or during installation may be shaped to create a conduit or raceway. Unlike conventional conduit, multiple sections may be cut to similar lengths when necessary since they can be stacked, making cutting or sawing of multiple pieces easier. Using the appropriate material, the surface can be made easily paintable so it can be installed on finished surface walls of existing buildings as easily as inside walls or cavities during new construction.

Indentations or slots are scored into the material and run along the length of the flat conduit to facilitate bending and shape forming during installation. The scoring may be done at the time of manufacture or may be done at the installation site. Each indentation may be positioned in relation to its adjacent indentation to vary the length of the section created by the angular bending of the material along the scoring. The angle of the bend along with the position of the scoring and number of scores in the material permit a wide range of shapes and sizes for the finished conduit. This allows for a customized look and installation in a variety of situations, such as in an existing wall or prior to drywall installation in a new construction. In addition, the positioning of multiple scorings in close proximity to each other allows for a rounded bending of the conduit, for situations where a rounded conduit is appropriate.

It is therefore an object of the present invention to provide a conduit that is less expensive to manufacture, handle, install, package, store and ship than conventional round, rectangular or square conduits.

It is a further object of the present invention to provide a conduit that may be easily installed in new construction or remodeling projects.

It is a further object of the present invention to provide a conduit that may have different finished shapes by simply scoring grooves into the flat conduit to vary the size of different sections, either during manufacture or at the project site.

It is still a further object of the present invention to provide a conduit that has its own attachment section for securing of the conduit to a structure without the need for clips, wires, or other fasteners.

Still other objects, features, and advantages of the present invention will become evident to those of ordinary skill in the art in light of the following,

### BRIEF DESCRIPTIONS OF THE DRAWINGS

FIG. 1 is an elevated end perspective view illustrating an unshaped, uninstalled flat conduit prior to indentation scoring and addition of mounting holes.

FIG. 2 is an elevated end perspective view illustrating one embodiment of an uninstalled, unshaped flat conduit after indentation scoring and addition of mounting holes.

FIG. 3 is an elevated end perspective view illustrating a second embodiment of an uninstalled, unshaped flat conduit after indentation scoring and addition of mounting holes.

FIG. 4 is an end view of the first embodiment of an uninstalled, unshaped flat conduit with indentation scoring.

FIG. 5 is an end view of an uninstalled, partially-shaped, angular-bent flat conduit.

FIG. 6 is an end view of a section of the third embodiment of an uninstalled, unshaped flat conduit with indentation scoring.

FIG. 7 is an end view of a section of the third embodiment of an uninstalled, partially-shaped, round-bend flat conduit.

FIG. 8 is an elevated end perspective view of the first embodiment of a shaped angular-bend conduit.

FIG. 9 is an elevated end perspective view of the third embodiment of a shaped, rounded cavity conduit.

FIG. 10 is a side perspective view of the first embodiment of a scored, unshaped flat conduit prior to attachment.

FIG. 11 is a side perspective view of the first embodiment of a scored, attached, partially-shaped conduit.

FIG. 12 is a side perspective view of the first embodiment of a scored, attached, partially-shaped conduit with cabling placed within the conduit.

FIG. 13 is a side perspective view of the first embodiment of a scored, attached, partially-shaped conduit with cabling placed within the conduit.

FIG. 14 is a side perspective view of the first embodiment of a completed scored, attached, shaped conduit with cabling enclosed within the conduit.

### DETAILED DESCRIPTION OF THE PREFERRED EMBODIMENTS

Although the disclosure hereof is detailed and exact to enable those skilled in the art to practice the invention, the physical embodiments herein disclosed merely exemplify the invention that may be embodied in other specific structure. While the preferred embodiment has been described, the details may be changed without departing from the invention, which is defined by the claims.

Like referenced characters are used throughout this description to identify like parts.

The present invention relates to a method and apparatus for the concealing and installing of wires, cables, fibers, pipes and the like within a structure.

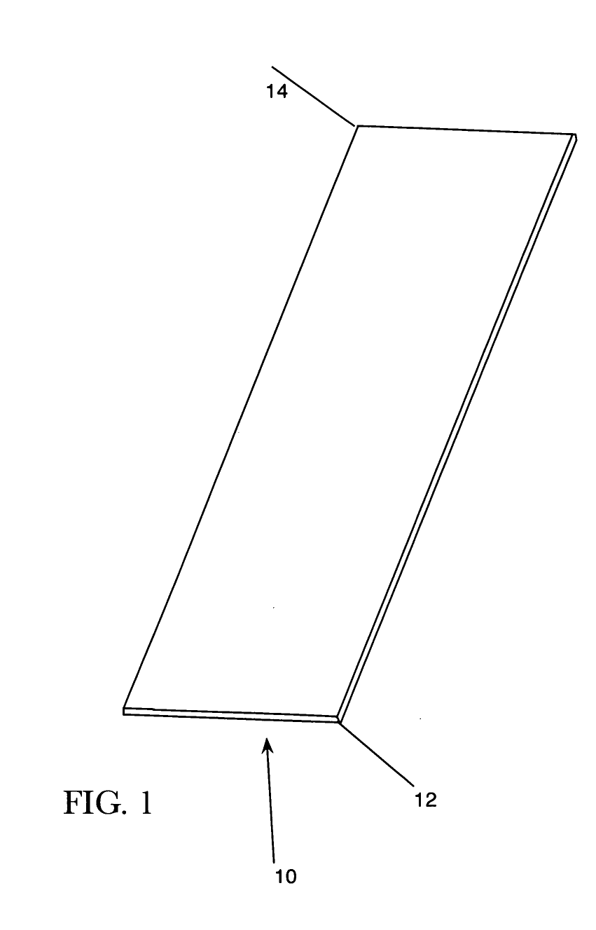

In FIG. 1, a conduit 10, extends along a longitudinal axis to a predetermined length, obtained by cutting the conduit 10 to form the conduit end 12 and the conduit end 14.

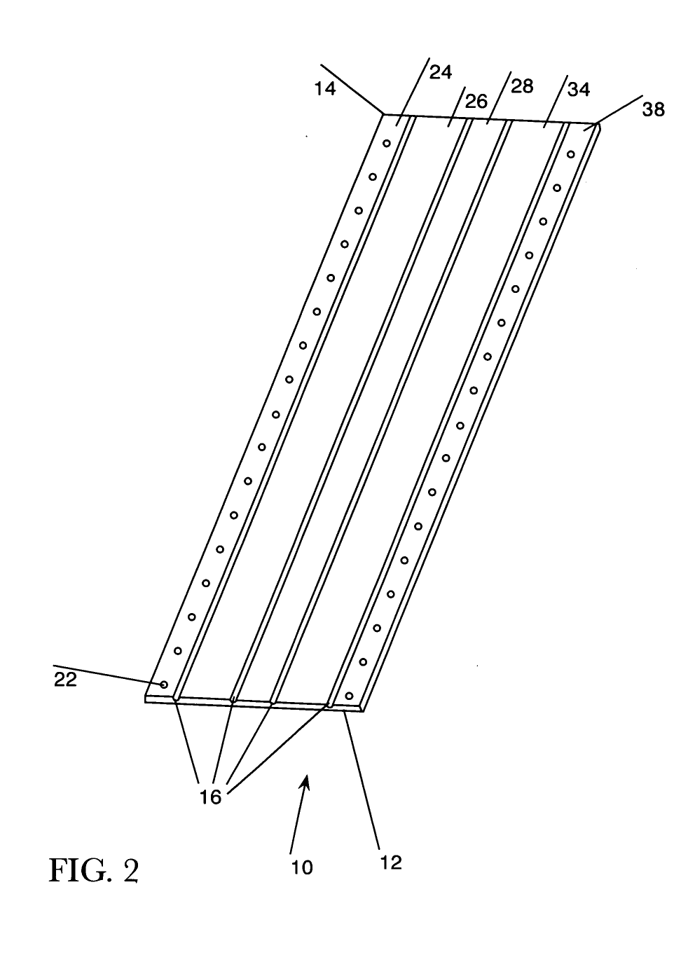

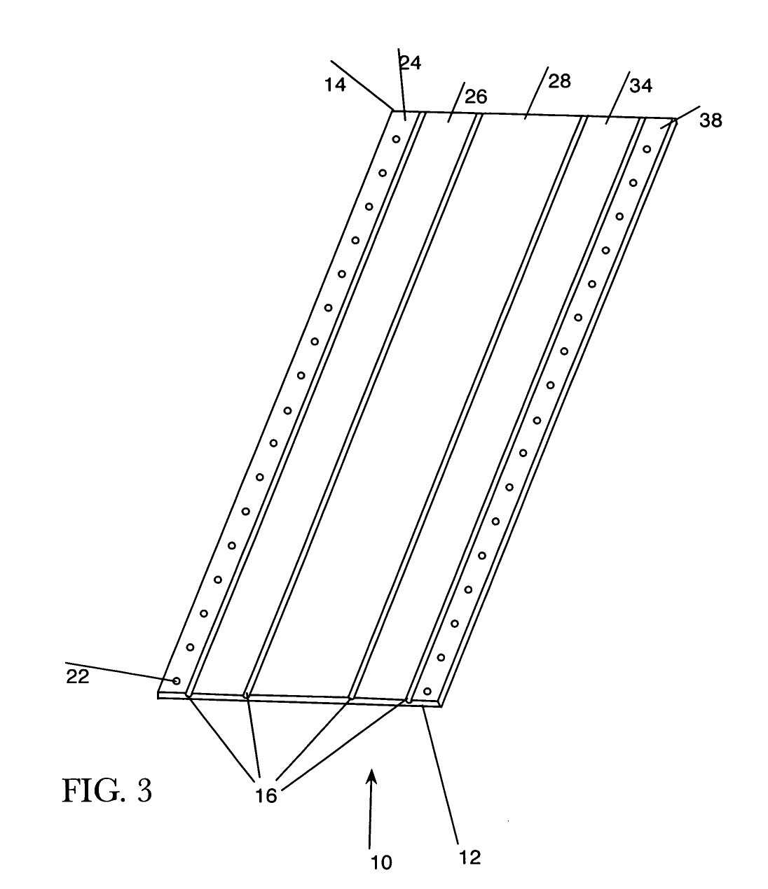

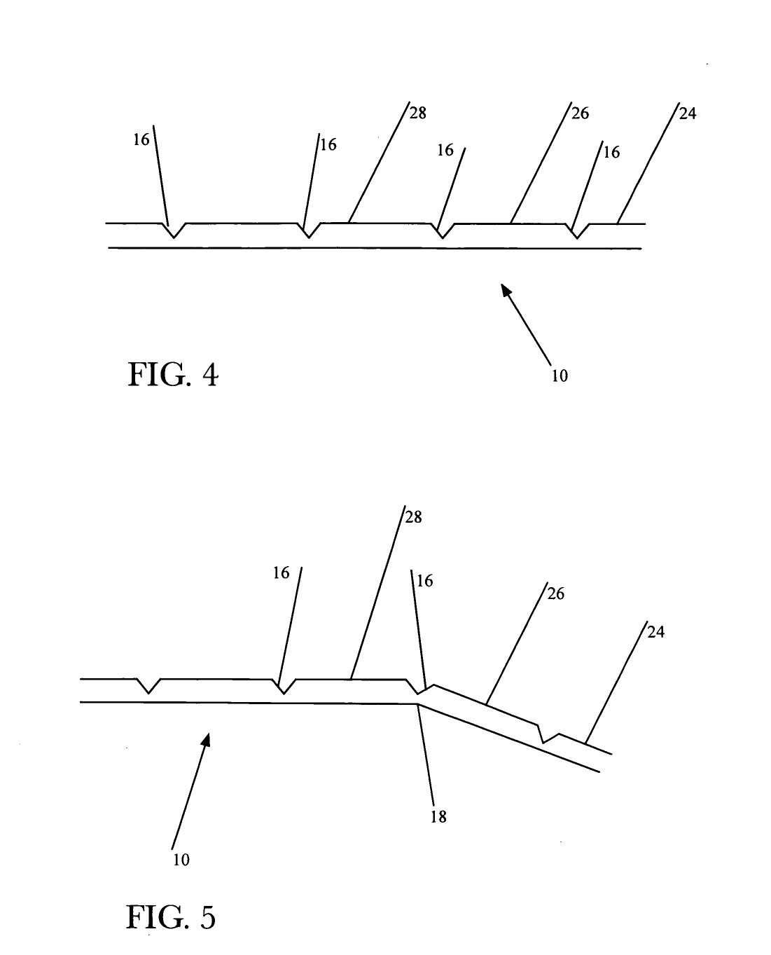

In FIGS. 2 and 3, the conduit 10, parallel to its longitudinal axis, contains a plurality of scored indentations 16 facilitating bending or shaping of the conduit 10 material along the scored indentations 16 to form various sections. The location of an individual scored indentation 16 in relation to an adjacent indentation 16 determines the length of the section created by an angular bend 18, which in turn determines the overall height and width of the conduit 10, as shown in FIGS. 4 and 5.

In FIG. 2, the scored indentions 16 allow for the bending of the conduit 10 to form an attachment section 24, a side section 26, a side section 34, and a top section 28. The bending of the conduit 10 along the scored indentations 16 at ninety-degree angles allows for the formation of the conduit 10 having a rectangular shape. Within the attachment section 24, a plurality of openings 22 are disposed to allow for the attachment of the conduit 10 to a surface on which it is to be mounted.

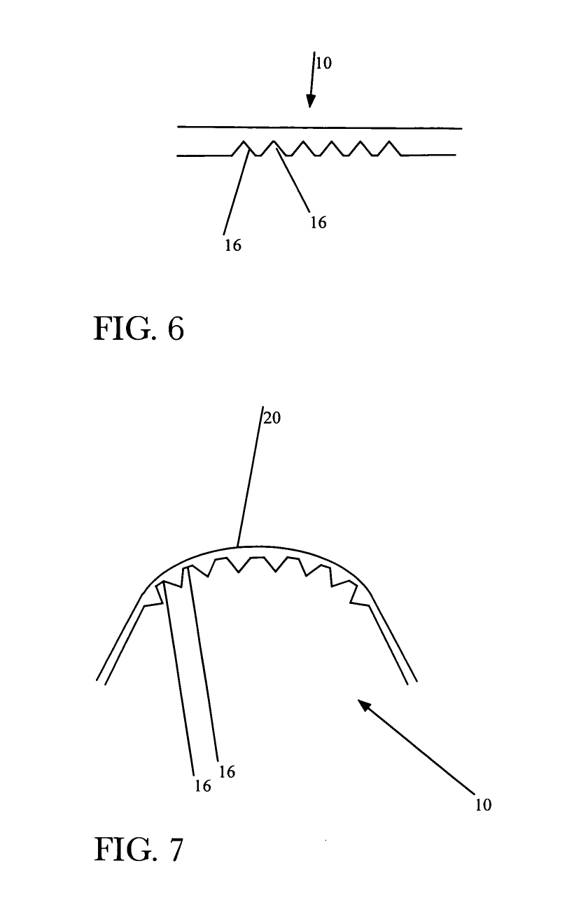

In FIG. 2, a first embodiment of the conduit 10 is displayed from which a rectangular finished conduit may be formed, where the top section 28 is wider than the side section 26 and side section 34, creating the conduit 10 where the depth of the conduit 10 is greater than its width. FIG. 3 depicts a second embodiment of the conduit 10, where the top section 28 is wider than the side section 26 and side section 34, creating the conduit 10 where the width of the conduit 10 is greater than its depth. In FIG. 4, the scored indentations 16 are shown spaced apart from each other, dividing the conduit 10 into the attachment sections 24, the side section 26 and the top section 28. As shown in FIG. 5, the bending of the conduit 10 along the scored indentation 16 forms an angular bend 18 in the conduit 10 that begins the formation of the side section 26. In a third embodiment, the scored indentations 16 may be spaced relatively close together, as shown in FIG. 6, to produce a rounded bend 20 in conduit 10, as shown in FIG. 7.

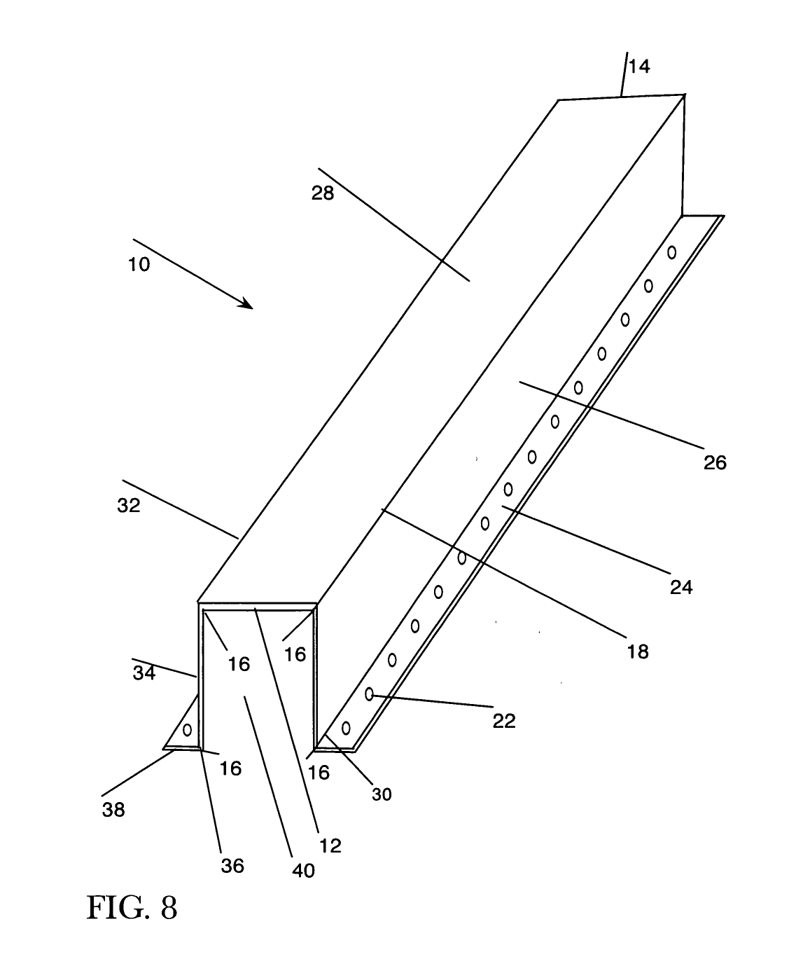

In FIG. 8 the first embodiment of finished conduit 10 is shown. The previously flat conduit 10 is bent at an angle at a bend 30 along the scored indentation 16 between the attachment section 24 and the side section 26, forming the attachment section 24 and beginning the formation of the side section 26. While the bend 30 is shown as a ninety degree angle in the first embodiment, any angle that allows for the positioning of attachment section 24 for attachment of the conduit 10 to a mounting surface may be utilized. A bend 18, an alternate interior angle in relation to the bend 30, completes the formation of the side section 26 and begins the formation of the top section 28. A bend 32, a consecutive interior angle in relation to bend 30, is made in to complete the formation of the top section 28 and begin the formation of the side section 34.

A bend 36, an alternate interior angle in relation to bend 32, completes the formation of the side section 34 and the completion of the attachment section 38, forming a cavity 40. While the bend 36 is shown as a ninety degree angle in the first embodiment, any angle that allows for the positioning of attachment section 34 for attachment of the conduit 10 to a mounting surface may be utilized. In the first embodiment, bend 18 and 32 are shown as ninety degree angles, however these may be at any angle that the user needs to achieve the desired shape of the completed conduit 10.

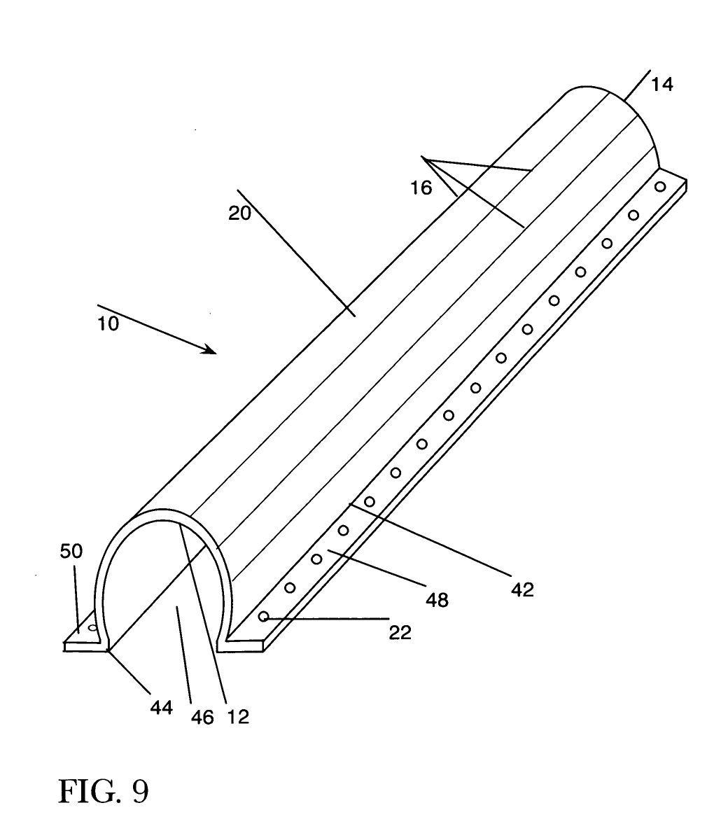

In FIG. 9, the third embodiment of finished conduit 10 is shown. The previously flat conduit 10 containing a plurality of tightly spaced scored indentations 16 (not shown in FIG. 9) are evenly and uniformly bent so that the scored indentations 16 collapse in on each other creating a round bend 20, forming a conduit with a rounded cavity 46. The attachment section 48 and the attachment section 50 are created by angularly bending the conduit 10 along the scored indentations 16 (not shown in FIG. 9) outwardly from the longitudinal axis of conduit 10 to form and angular bend 44 and an angular bend 42.

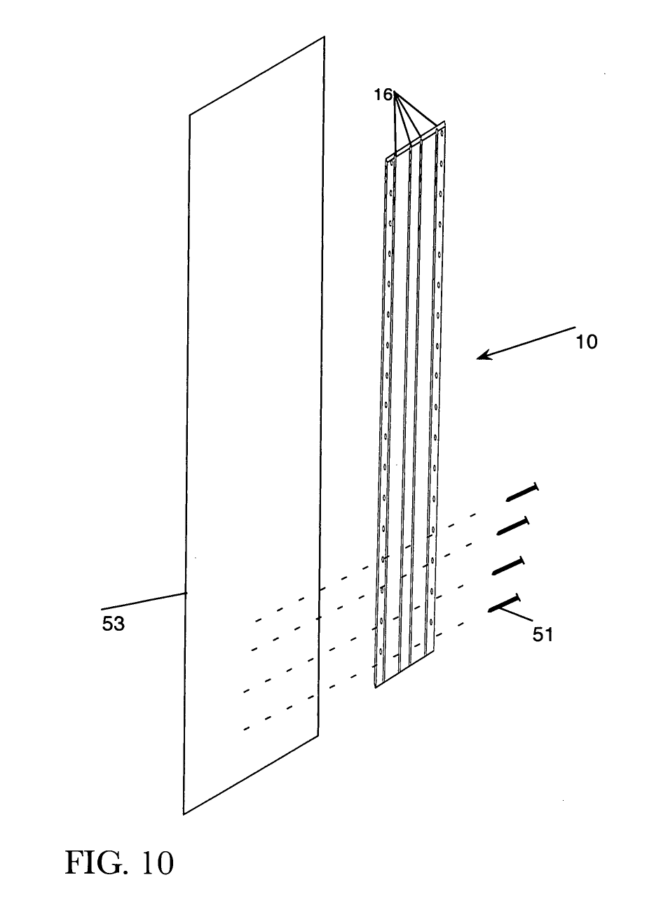

In FIG. 10, the first embodiment of the conduit 10 prior to installation and shaping is shown. The conduit 10 is scored along scored indentations 16 and is placed upon a mounting surface 53 for attachment. A plurality of fasteners 51 are placed through the openings 22 disposed within the attachment section 24 of the conduit 10. The fasteners 51 are driven into the mounting surface 53, thereby securing the conduit 10 to the mounting surface 53. While the fasteners 51 shown being used for securing the conduit 10 are nails, any suitable fastening device, such as staples or screws may be used.

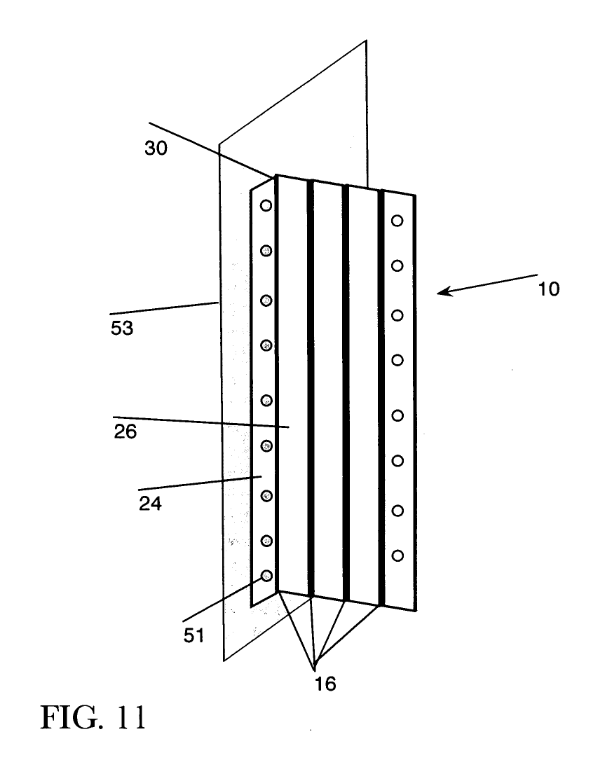

In FIG. 11, the conduit 10 is shown secured to the mounting surface 53 by means of the fasteners 51. The conduit 10 has been bent at an angle at the bend 30 along scored indentation 16, forming the attachment section 24 and beginning the formation of the side section 26.

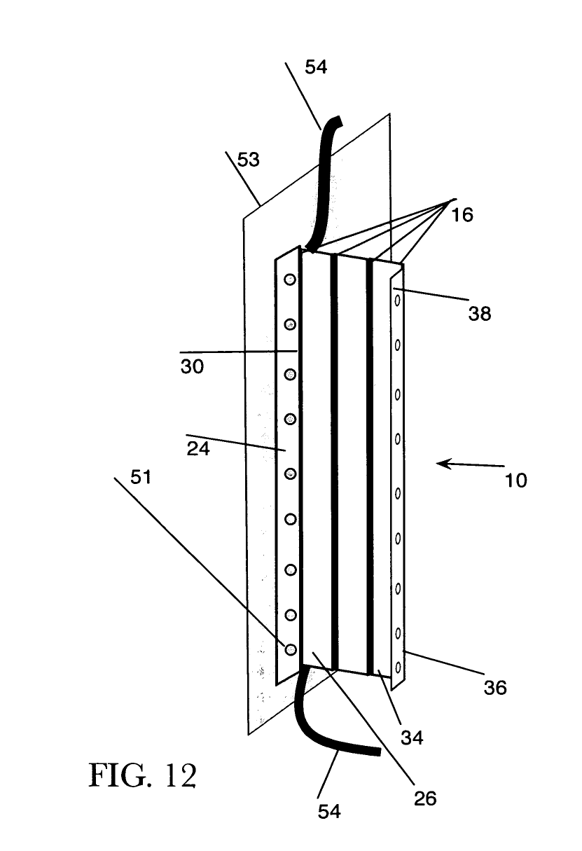

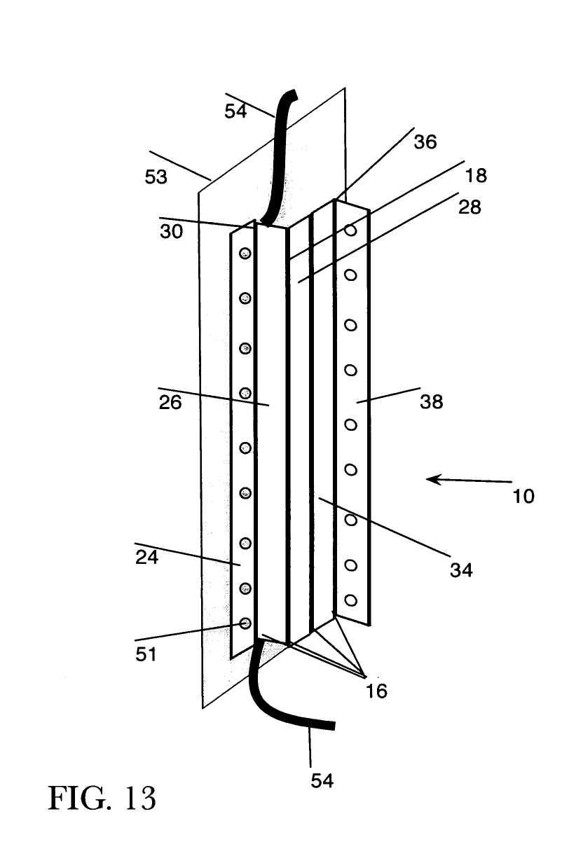

In FIG. 12, the conduit 10 is shown secured to the mounting surface 53 through the attachment section 24 by means of the fasteners 51. The conduit 10 has been bent at an angle along the bend 30 along scored indentation 16, forming the attachment section 24 and beginning the formation of the side section 26. The conduit 10 has also been bent at an angle at the bend 36 along scored indentation 16, forming the attachment section 38 and beginning the formation of the side section 34. A cable 54 has been placed against the mounting surface 53 for eventual enclosure by the conduit 10.

In FIG. 13, the conduit 10 is shown secured to the mounting surface 53 through the attachment section 24 by means of the fasteners 51. The conduit 10 has been bent at an angle along the bend 30 along scored indentation 16, forming the attachment section 24 and beginning the formation of the side section 26. The conduit 10 has also been bent at an angle at the bend 36 along scored indentation 16, forming the attachment section 38 and beginning the formation of the side section 34. The cable 54 has been placed against the mounting surface 53 for eventual enclosure by the conduit 10. The conduit 10 has also been further bent at an angle at the bend 18 along scored indentation 16, forming the top section 28.

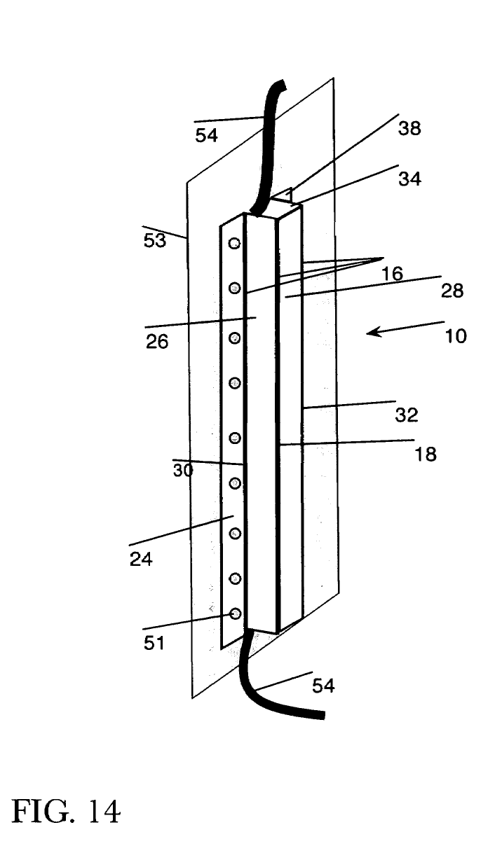

In FIG. 14, the conduit 10 is shown secured to the mounting surface 53 through the attachment section 24 by means of the fasteners 51. The conduit 10 has been bent at an angle along the bend 30 along scored indentation 16, forming the attachment section 24 and beginning the formation of the side section 26. The conduit 10 has also been bent at an angle at the bend 36 along scored indentation 16, forming the attachment section 38 and beginning the formation of the side section 34. The cable 54 has been placed against the mounting surface 53 for eventual enclosure by the conduit 10. The conduit 10 has also been further bent at an angle at the bend 18 along scored indentation 16, forming the top section 28. The bend 32 in the conduit 10 completes the shaping of the conduit 10 by finishing the side section 34 and top section 28. Fasteners 51 (not shown) are affixed through the openings 22 in attachment section 38, securing the conduit 10 to the mounting surface 53 and enclosing the cable 54 within cavity 40.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. Although the present invention has been described in terms of the foregoing preferred embodiments, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

I claim:

1. A conduit for installing and concealing wires, cables, fibers, pipes, and the like within a structure, comprising:
a generally flat strip of flexible material extending along an axis;
a plurality of longitudinal scored indentations disposed in the flexible material that allow folding of the flexible material to create a channel adapted to conceal the wires, cables, fibers, pipes, and the like within; and
the scored indentations being variable in distance from each other to customize the shape of the conduit.

2. The conduit of claim 1, wherein the flexible material has disposed therein additional longitudinal scored indentations parallel to the axis that allow folding of the flexible material to create attachment sections adapted for facilitating the mounting of the conduit onto a building or structure.

3. The conduit of claim 2, wherein the attachment sections reside exterior to the channel.

4. The conduit of claim 2, wherein the attachment sections are scored with holes allowing for the insertion of a fastening means.

5. The conduit of claim 1, wherein the flexible material is polyvinyl.

6. The conduit of claim 4, wherein the fastening means are nails, staples or screws.

7. The conduit of claim 1, wherein the plurality of scored indentations disposed in the flexible material are folded in ninety degree angles to form a rectangular shaped channel.

8. The conduit of claim 1, wherein the plurality of scored indentations disposed in the flexible material are folded at obtuse angles to create a rounded conduit.

9. A method of installing and concealing wires, cables, fibers, pipes, and the like within a structure, comprising:
cutting a generally flat strip of flexible material extending along an axis to a desired length;
scoring the flexible material with a plurality of longitudinal indentations;
bending the flexible material at an angle along the longitudinal indentations to form a conduit;
placing wires, cables, fibers pipes, or the like within the conduit; and
mounting the conduit to a building or structure by attaching the conduit to the building or structure.

10. A method of installing and concealing wires, cables, fibers, pipes, and the like within a structure, comprising:
cutting a generally flat strip of flexible material extending along an axis to a desired length;
scoring the flexible material with inner and outer longitudinal indentations;
bending the flexible material at an angle along the inner longitudinal indentations to form a cavity;
bending the flexible material along the outer longitudinal indentations to form attachment sections;
placing wires, cables, fibers pipes, or the like within the cavity; and
securing the attachment sections to the building or structure, thereby mounting the conduit to a building or structure.

11. The method of claim 9, wherein the attachment sections are scored with holes that allow the insertion of fasteners.

12. The method of claim 10, wherein bending the flexible material along the outer longitudinal indentations to form attachment sections comprises bending the flexible material such that the attachment sections reside exterior to the cavity.
